(19) United States
(12) Patent Application Publication
(10) Pub. No.: US 2013/0091051 A1
(43) Pub. Date: Apr. 11, 2013

(54) COMPUTER-BASED SYSTEM AND METHODS FOR EVALUATING MORTGAGE PREPAYMENT RISK

(71) Applicant: RON GINN, ST. AUGUSTINE, FL (US)

(72) Inventor: RON GINN, ST. AUGUSTINE, FL (US)

(21) Appl. No.: 13/648,599

(22) Filed: Oct. 10, 2012

Related U.S. Application Data
(60) Provisional application No. 61/545,258, filed on Oct. 10, 2011.

(51) Int. Cl. G06Q 40/02

(52) U.S. Cl. 705/38

(57) ABSTRACT

A computer-based system for providing mortgage prepayment risk information includes tangible memory storing real estate data associated with an article of real property and mortgage data associated with a mortgage for the real property. The mortgage data includes a mortgagee defined time period for maintaining the mortgage. A computer system having at least one processor operably coupled to the tangible memory is configured to calculate a return on investment value based on the mortgage data and provide a mortgage agent with the mortgagee defined time period. A computer-based method for evaluating mortgage prepayment risk includes receiving, at a computer interface, the mortgagee defined time period for maintaining the mortgage, wherein the mortgagee defined time period is obtained from the computer system.

### CROSS-REFERENCE TO RELATED APPLICATION

Priority is claimed to provisional application Ser. No. 61/545,258 filed Oct. 10, 2011, titled “System and Method for Evaluating Investment Risk,” which is incorporated by reference in its entirety.

### FIELD OF THE INVENTION

This invention relates to the field of evaluating the risk of mortgage prepayment.

### BACKGROUND

Loan prepayment occurs when a borrower pays the balance of a loan before the term of the loan expires. The risk of loan prepayment is important to evaluate because, when a borrower prepays the loan, the interest income the lender expected to obtain from the loan is decreased. In the case of mortgages, prepayment is considered a significant risk to mortgage based investments such as mortgage backed securities. Because of prepayment risk, mortgage providers and mortgage service providers attempt to assess the risk that mortgages will be prepaid by using statistical data that allows them to value their respective mortgages more accurately.

One of the conventional techniques for evaluating prepayment risk is based on a calculation called a “prepayment assumption.” Although these existing prepayment assumptions work to some degree, they are not without their drawbacks.

### SUMMARY

I have observed that most, if not all, of the conventional prepayment assumption algorithms depend on mortgage prepayment statistics derived solely from historical, or rearward-looking, mortgage prepayment data. This limits the accuracy by which mortgages can be valued. Embodiments of my invention provide a system and methods that assist with evaluating prepayment risk using, at least in part, non-historical, forward-looking mortgage data in the form of a mortgagee defined time period for maintaining the mortgage and/or a return on investment value.

In accordance with a system aspect of the invention, a computer-based system for providing mortgage prepayment risk information comprises tangible memory that stores real estate data associated with an article of real property and mortgage data associated with a mortgage for the real property. The mortgage data comprise the mortgagee defined time period for maintaining the mortgage. A computer system having at least one processor is operably coupled to the tangible memory and is configured to calculate a return on investment value based on the mortgage data and provide a mortgage agent with the mortgagee defined time period.

In accordance with a method aspect of the invention, a computer-based method for evaluating mortgage prepayment risk comprises receiving, at a computer interface, the mortgagee defined time period for maintaining the mortgage from a computer system configured as described above.

In accordance with another method aspect of the invention, a computer-based method for providing mortgage prepayment risk information comprises receiving real estate data associated with an article of real property and mortgage data associated with a mortgage of the real property, the mortgage data comprising the mortgagee defined time period for maintaining the mortgage, storing the real estate data and mortgage data on tangible machine readable memory, calculating a return on investment value by applying a return on investment algorithm to the mortgage data using a computer processor in data communication with the tangible machine readable memory, and providing a mortgage agent with the mortgagee defined time period.

These and other aspects, embodiments, and features of the invention will be better understood in the context of the accompanying drawings and the following Detailed Description of Preferred Embodiments.

### BRIEF DESCRIPTION OF THE DRAWINGS

FIG. 1 is a schematic diagram of a computer-based system for providing mortgage prepayment risk information, according to an embodiment of the invention;

FIG. 2 is a schematic diagram of modules of the computer-based system of FIG. 1;

FIG. 3 is a schematic diagram illustrating the interaction between elements of the computer-based system of FIG. 1;

FIG. 4 is schematic diagram illustrating exemplary data fields for use with the computer-based system of FIG. 1;

FIG. 5 is schematic diagram illustrating exemplary data fields for use with the computer-based system of FIG. 1;

FIG. 6 is schematic diagram illustrating exemplary data fields for use with the computer-based system of FIG. 1;

FIG. 7 is a flow diagram of a method for providing mortgage prepayment risk information, according to a method aspect of the invention; and

FIG. 8 is a schematic diagram of a social networking interface in communication with the computer-based system of FIG. 1.

### DETAILED DESCRIPTION OF PREFERRED EMBODIMENTS

In the Summary above and in the Detailed Description of Preferred Embodiments, reference is made to particular features (including method steps) of the invention. Where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other features, ingredients, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

This invention may be embodied in many different forms and should not be construed as limited to the embodiments set forth herein. Rather, these embodiments are provided so that this disclosure will convey preferred embodiments of the invention to those skilled in the art.

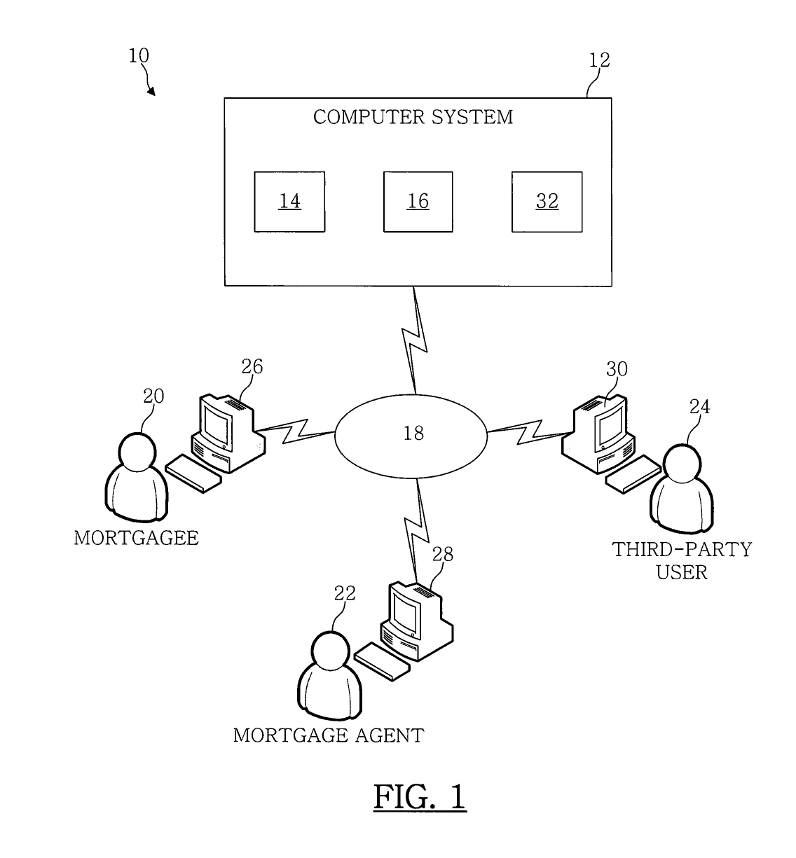

Referring to FIG. 1 a computer-based system 10 for providing mortgage prepayment risk information, according to an embodiment of the invention, includes a computer system 12 operating with one or more processors 14 in signal communication with machine-readable memory 16. The computer system 12 communicates with a plurality of users 20-24 through a network 18. Each user 20-24 communicates with the system 10 via one or more user computers 26-30 in signal communication with the network 18.

In the embodiment of the computer-based system 10 shown in FIG. 1, the users include a mortgagee 20, mortgage agent 22, and other third-party users 24. The processor 14 and memory 16 are signal communication with one or more real estate databases 32.

Examples of suitable user computers 26-30 include conventional desktop or laptop computers that include a keyboard, screen, mouse, and network connection device. Other suitable user computers 26-30 include mobile communications devices such as smart phones or tablet PCs. Each user computer 26-30 is adapted to communicate with the computer system 12 via the network 18. In the embodiment of FIG. 1, the mortgagee 20 operates a mortgagee computer 26, the mortgage agent 22 operates a mortgage agent computer 28, and the third-party user(s) operate a third-party user computer(s) 30. The user computers 26-30 will typically access the Internet directly through an Internet service provider (ISP) or indirectly through a network interface. Access directly or through a network 18 other than the Internet may alternatively or also be allowed.

The computer system 12 is configured to execute an interface at each user computer 26-30. The interface is preferably in the form of a page that appears on the screen and allows the user 26-30 to retrieve data from and input data into the computer system 12. In preferred embodiments, the interface is executed by the computer system 12 as a website.

Typically, third-party users 24 of the computer system 12 are parties that serve a function in buying and/or selling real estate. Examples of third-party 24 users include, but are not limited to, sellers, buyers, prospective buyers, underwriters, insurers, building inspectors, title insurers, and/or real estate researchers.

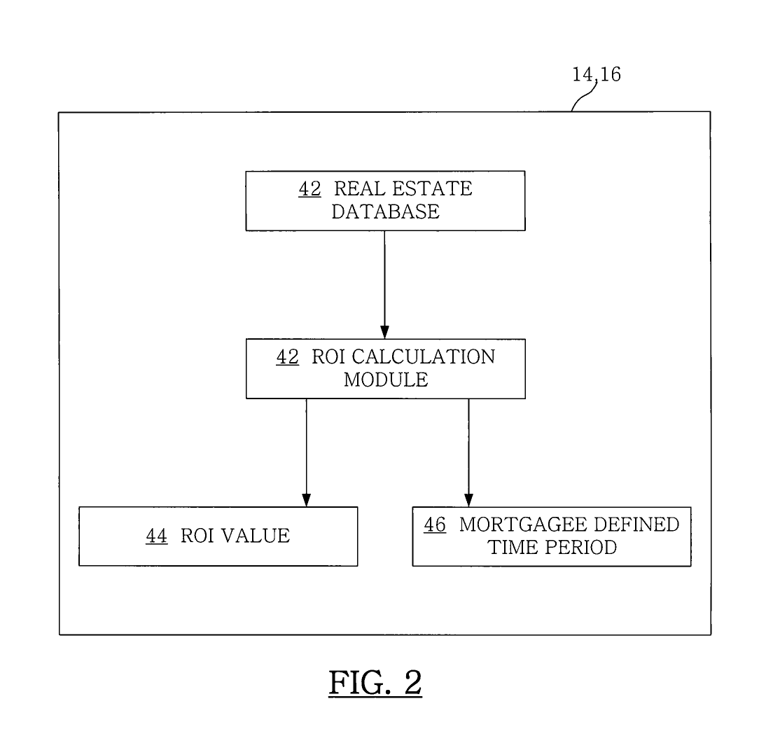

Referring to FIG. 2, the processor 14 and memory 16 are configured to execute the real estate database 32 and a return on investment (ROI) calculation module 42. The (ROI) calculation module 42 receives real estate data from the real estate database 32. Based at least in part on the real estate data, the ROI calculation module 42 calculates a ROI value 44 for a particular property. The ROI calculation module 42 also outputs a mortgagee defined time period 46, which is the amount of time the mortgagee 20 expects to maintain the mortgage. The computer system 12 subsequently communicates both the ROI value 44 and mortgagee defined time period 46 to the mortgage agent's computer 28.

The mortgage agent's computer 28 receives the ROI value 44 and mortgagee defined time period 46. A mortgage agent 22 is a person or entity that sells, owns, manages, values, and/or services mortgages. Mortgage agents 22 include, but are not limited to, mortgagors, lenders, banks, mortgage service providers, and insurance company representatives. These data allow the mortgage agent 22 to assess the value of the mortgage by combining the mortgage agent's 22 prepayment assumptions based on historical data with the ROI value 44 and mortgagee defined time period 46. The mortgagee defined time period 46 provides the mortgage agent 22 with a piece of data that indicates whether the mortgagee is likely to prepay the mortgage in the future.

By way of example, if the mortgagee 20 has a thirty year mortgage on a property, the amount of interest the mortgagor will expect to collect is based on the thirty year term. However, if the mortgagee 20 prepays the mortgage balance, the realized value of the mortgage to the mortgagor decreases. The mortgagee defined time period 46 is a period of time that the mortgagee 20 expects to maintain the mortgage on the property. By having this data point, the mortgage agent 22 is able to better estimate the value of the mortgage that the mortgagor will realize.

Advantageously, the mortgagee defined time period 46 provides the mortgage agent 22 with forward-looking information it does not otherwise possess. The mortgagee defined time period 46 provides an estimate of what may occur with respect to a given property in the future and enables mortgage agents 22 to perform more accurate and thorough risk analysis that will, in turn, lead to better valuations of mortgages.

The ROI calculation module 42 is adapted to calculate ROI scores for real estate based on user input. The calculation module 42 applies a “discounted cash flow” (DCF) algorithm to the real estate data in the real estate database 32 to perform the calculation. In the field of finance, DCF analysis refers to a method of valuing an asset by taking the time value of money into account. The DCF algorithm uses both incoming and outgoing cash flow and a discount rate to evaluate the ROI score. The DCF algorithm is conventionally used to assess various types of investments, including real estate.

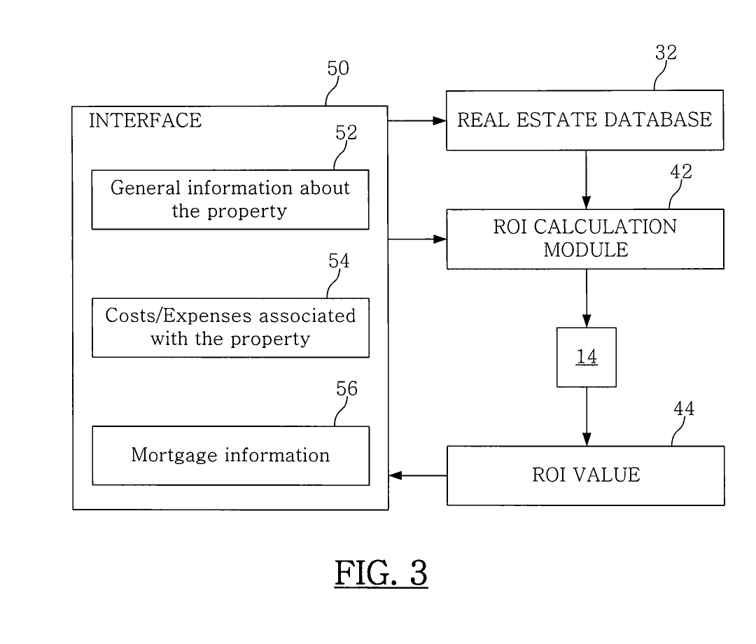

Additional details about the operation of the ROI calculation module 42 are now described with reference to FIG. 3. At the interface 50, the mortgagee 20 inputs data into a plurality of data fields 52-56. The real estate database 32 stores the input data. The processor 14 retrieves the input data and communicates the data to the ROI calculation module 42, which instructs the processor 14 to apply the DCF algorithm for calculating the ROI value 44 for the mortgagee 20. The computer system 12 then displays the ROI value 44 at the interface 50 so that it can be viewed by the mortgagee 20. The general operation of the ROI calculation module 42 is typically the same if the user is a mortgage agent 22 or third-party user 24.

The data fields 52-56 presented to the user 20-24 are geared to the user's specific needs and level of sophistication. For example, the data fields 52-56 may be directed to a sophisticated real estate investor, a home owner who will most likely be evaluating the return on investment of a primary residence, somewhat more sophisticated investors who will likely have more capital and be seeking secondary home investment properties, and to professional investors who routinely invest in real estate and may be doing so as the investor's primary business. The data fields 52-56 may also be tailored to the type of property involved, such as commercial or residential, and may also be further divided by sub-categories including commercial retail property, commercial office space, residential single-family homes, residential condos, residential time shares, etc. The categories may also be divided according to a user's 20-24 involvement in the real estate transaction, including whether the user is a buyer, seller, mortgage agent 22, insurance company, inspector, etc. for the property. These categories are provided solely as examples and are not required for implementation of all embodiments of the invention.

The computer system 12 determines the user's 20-24 category by asking the user 20-24 a series of questions about the user's experience and objectives. Based on the user's category, the system 10 selects a series of pre-determined investment related questions and presents those investment-related questions to the user 20-24 in the form of the data fields 52-56. The data fields 52-56 include text and/or number fillable blanks into which the user answers each question. The data fields 52-56 are presented to the user 20-24 in a series of pages. The pages are organized into general information about the property (the general information page), costs/expenses associated with the property (the costs/expenses page), and mortgage information (the mortgage information page).

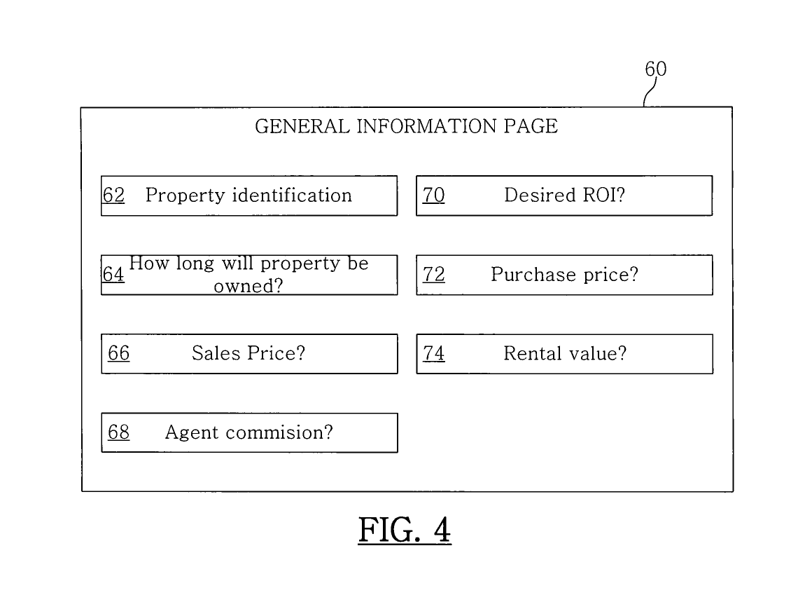

Referring to FIG. 4, an example of a general information page 60 in accordance with an embodiment of the invention includes data fields 62-74 that allow the user 20-24 to input data about the property of interest. In the property identification field 62, the user 20-24 inputs the address of the property. In the “how long will the property be owned field” 64, the user inputs the amount of time that the user believes the property will be owned. When the user 20-24 is a mortgagee, the “how long will the property be owned field” 64 sets the mortgagee defined time period 46. In the “sales price” field 66, the user inputs the price for which the seller will sell the property. In the “agent commission” field 68, the user inputs the amount of commission, if any, that must be paid to a buyer's or seller's real estate agent. In the “desired ROI” field 70, the user inputs the percent return on investment the user desires to obtain for the property. In the “purchase price” field 72, the user inputs the purchase price or estimated purchase price of the property. The user inputs its rental value in the “rental value” field 74. Suitable measures of rental value include the rental price per period of time and the growth rate of the rental price during subsequent rental periods. The sales price, desire ROI, and rental value serve the tangential function of providing forward looking sentiment.

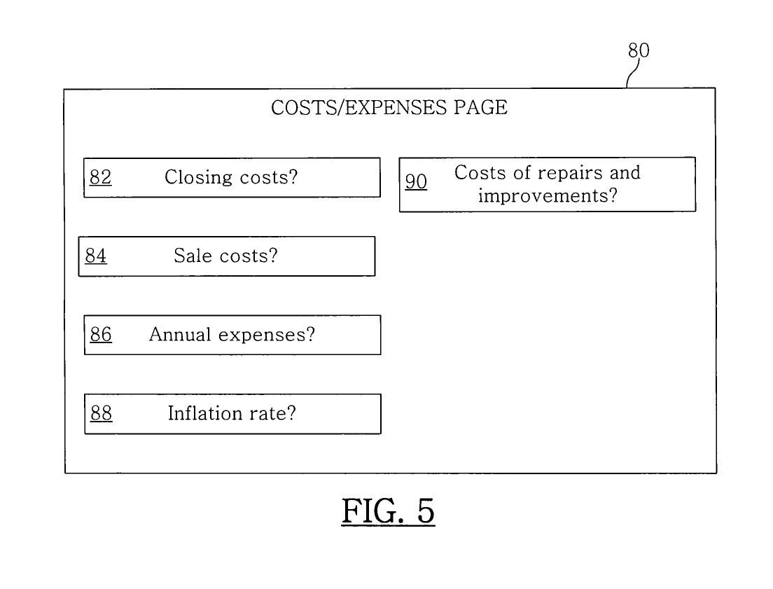

Referring to FIG. 5, an example of a costs/expenses page 80 in accordance with an embodiment of the invention includes data fields 82-90 that allow the user to input data about the costs and/or expenses associated with the property of interest. In the “closing costs” field 82, the user inputs the amount of closing costs associated with a transaction for the property. Any expenses associated with the transaction, such as inspection fees and/or title insurance fees are input into the “sale costs” field 84. Annual expenses such as property taxes, property insurance, and maintenance costs are entered into the “annual expenses” field 86. The user enters the inflation rate in the “inflation rate” field 88. The cost of repairs and improvements, including any one time upgrades are entered in the “costs of repairs and improvements” field 90. Preferably, the “costs of repairs and improvements” field allows the user to specify the estimated cost and during which year of ownership the user intends to incur such costs.

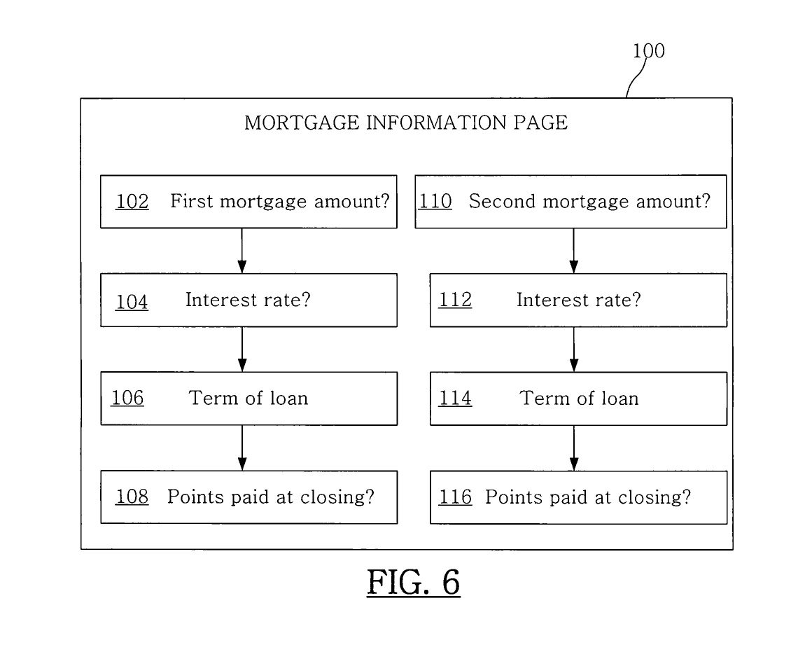

Referring to FIG. 6, the mortgage information page 100 allows a user 20-24 to input data about any mortgages on the property of interest. In situations in which the property is mortgaged by a first mortgage, the user 20-24 inputs data about the first mortgage by completing the data fields associated with the first mortgage. In the “first mortgage amount” data field 102, the user inputs the amount of the first mortgage. In the “interest rate” field 104, the user inputs the interest rate for the first mortgage or rate terms if the mortgage is adjustable. In the “term of loan” field 106, the user inputs the time period over which the first mortgage is to be amortized. If points were paid for first mortgage at closing, the user inputs the amount into the “points paid at closing” field 108. If prepayment points were paid, these prepayment points are also entered in the “points paid at closing field” 108.

If the property is mortgaged by a second mortgage, the user inputs the corresponding data for the second mortgage in the data fields 110-116 for the second mortgage.

It is important to note that embodiments of the invention in no way limited to the above described data fields. There are many other data fields associated with questions that relate to a return on investment that can be asked. By way of example, other embodiments include a data field allowing the user to input the number years a current property owner has owned the property or the number of years a potential buyer intends to own the property if the potential buyer purchases it.

Referring back now to FIGS. 1 and 2, once the user 20-24 completes its respective set of data fields, the system 10 stores the user's 20-24 input on the real estate database 32. Upon receiving instructions to execute an ROI calculation, the ROI calculation module 42 receives the input from the data fields and performs the ROI calculation. The results, in the form of an ROI value 44 are presented to the user 20-24 at the interface 50. Optionally, the system 10 then provides the user 20-24 with options for changing the user's 20-24 input based on the ROI value 44. In other embodiments, the data used by the ROI module 42 to calculate the ROI value 44 are input by a plurality of users 20-24.

The database 32 stores data about each property for which an ROI value calculated. Once enough ROI values have been calculated, the database 32 is used to provide a substantial amount of financial information to an interested party. For example, the database 32 can be used to provide ROI information about a specific piece of property, neighborhood, city, state, and so forth.

The database 32 may also store publicly available information for each piece of property on which a ROI value 42 is calculated. For example, public records information about purchase price and date, amount and terms of financing, and the date and price a property was sold can be input via an interface. Other public records information that can be input includes, but is not limited to tax records, census records, year built, current market sales/mortgage term comparables of nearby properties, and foreclosure filings. The database 32 may also store information from private industry information providers. These inputs along with some standardized expense and rent assumptions allow for the creation of valuable economic data that data can help answer questions such as “How much are Americans earning on their real estate investments, compared to stocks, bonds, annuities, etc.” or how much Americans are effectively paying for mortgages, using the internal rate of return of mortgages at loan level. If the database 32 is populated with publicly available information, the publicly available information is optionally taken into account in the ROI value 44.

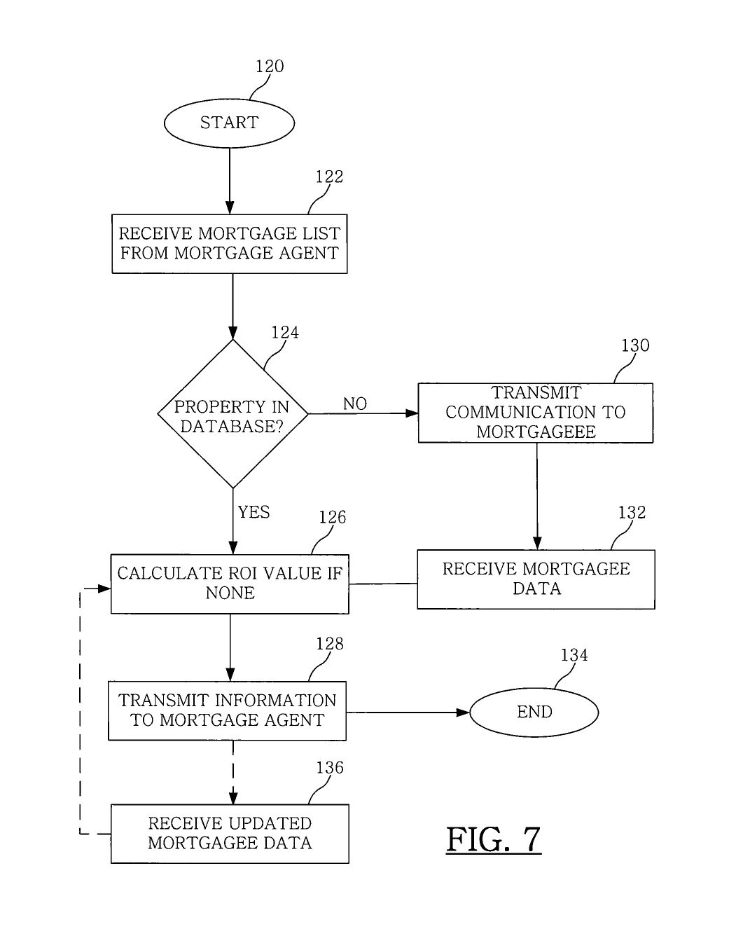

The overall operation of the system 10 is now described in connection with FIG. 7. Referring to FIG. 7, a method of providing prepayment risk information begins at block 120. At block 122, the system receives a list of mortgages for evaluation. The list of mortgages includes information about one or more mortgages that the mortgage agent desires to individually run through the system so that the mortgage agent will be able to obtain a ROI score and the mortgagee defined time period. At block 124, the system determines whether information about each property associated with a mortgage on the list is stored on the real estate database. At block 126, the system calculates the ROI for the properties on the database if a ROI score for the property has not otherwise been calculated. For the properties that are not on the database, the system transmits a communication to the mortgagee (block 130), directing the mortgagee to access the system, input mortgagee data into the data fields, and calculate a ROI value for the mortgaged property. The system subsequently receives the mortgagee data (block 132) and calculates the ROI value (block 126) for the mortgagee. Again, at block 128 the system transmits the ROI value and mortgagee defined time period to the mortgage agent.

The mortgage agent 22 can use the ROI value 44 along with the mortgagee defined time period 42 to evaluate the prepayment risk. The mortgage agent 22 can also use these data as a pricing mechanism for what a prospective investor might be willing to pay if the mortgagor liquidates the property after foreclosure. Further, by collecting ownership, repair, and improvement costs the computer system 12 is able to provide the mortgage agent 22 with information about the condition of the property. This can also be used to estimate the credit worthiness of the mortgagee 20.

Optionally, the system and method are configured to receive updated information about the property after the first ROI value is calculated so that subsequent ROI values and/or updated mortgagee defined time periods can be provided to the mortgage agent. This optional step is identified at block 136. At block 136 the system receives the updated mortgagee data when the mortgagee accesses the system and provides updated information in the form of data entered into one or more of the data fields. If the mortgagee instructs the system to re-calculate the ROI value (block 126) based on the updated information, the system transmits the updated ROI value to the mortgage agent (block 128). If the mortgagee updates the mortgagee defined time period, the system also transmits the updated mortgagee defined time period to the mortgage agent. This allows the system to provided up to date mortgagee data so that the mortgage agent can routinely re-evaluate the prepayment risk associated with a particular mortgage. This is considerably advantageous over conventional methods for evaluating prepayment risk because the conventional methods are based on historical data. It is often the case that the conventional methods only take into account the data on hand when the mortgage was executed and use different automated valuation models. They only use historical data regarding the creditworthiness of the mortgagee.

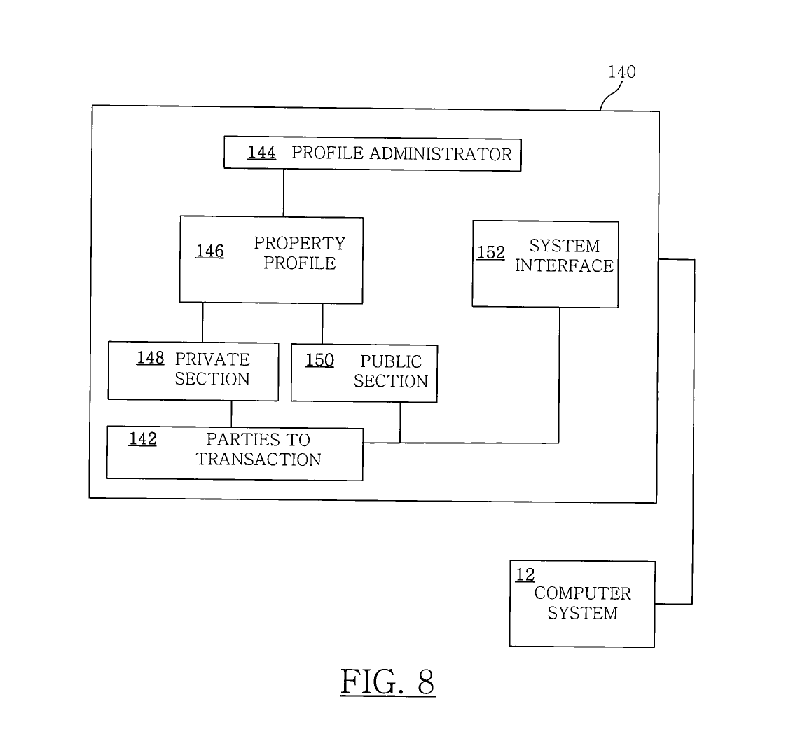

Referring to FIG. 8, in accordance with another embodiment of the invention, the system 10 and method are implemented via a social networking interface 140 that brings parties to a real estate transaction together in such a way that the steps involved in making the transaction are performed therethrough. The documents involved with the transaction are viewed and distributed via the social networking interface 140 as well. In the context of FIG. 1 the parties to the real estate transaction 142 communicate with the system as a user 20-24.

In use, a profile administrator 144 creates an account and enters information about the subject property to create a property profile 146 that displays information about the property on a webpage. The property profile 146 is activated when a property owner claims it. The profile administrator 144 who, in a typical case, is the property owner or agent thereof, controls the property profile 146 and has the ability to add and/or make private the information from the property profile 146 as desired.

The property profile 146 is preferably partitioned into a private section 148 and a public section 150. The public section 150 includes information that the profile administrator 144 selects as being public. Preferably, this includes general information about the property, such as information that is generally provided by conventional property listing services such as the Multiple Listing Service (“MLS”). The public section 150 may be openly accessed and viewed via the social networking website 140 by, for example, a potential buyer searching properties or a real estate professional comparing properties. In this manner, the public section 150 functions as a conventional real estate listing service.

The private section 148 is preferably adapted for use in a real estate transaction. Accordingly, when a real estate transaction is underway, the parties to the transaction 142 access the private section by creating an account on the social networking website 140 and querying the profile administrator 144 to provide access to the private section 148. Examples of parties 142 that may be involved in a real estate transaction include, but are not limited to, the seller, seller's agent, buyer, buyer's agent, the mortgagor or mortgage agent, the buyer's and seller's attorneys, the underwriter, the title company, the escrow agent, and/or relevant government entities (federal, state, and/or local), among many others. Electronic devices associated with a property and connected to the internet, such as internet equipped appliances or security systems may also be able to communicate with the private section 148 so that they may be monitored and/or controlled using encryption. The documents associated with the transaction such as contracts, appraisals, mortgage documents, inspection documents, for example, may be uploaded onto the private section 148 by the relevant party via the user's computer 26-30. Accordingly, the private section 148 provides a single location for the transaction documents to be submitted, downloaded, reviewed, and organized. The documents related to the transaction are stored on the real estate database 32.

A typical real estate transaction proceeds through a series of steps which are indicated on the property profile 146, preferably in the private section 148 by displaying a transaction status indicator or a transaction timeline. Examples of status indicators that may be used include but are not limited to: not for sale, for sale, listed for sale (where a broker controls the property profile), contract pending, offer made, under contract, contract accepted, transaction pending, sale complete, or transaction closed. When all of the steps of the transaction are complete, the sale is finalized. When the sale is finalized, control of the property profile 146 is preferably transferred from the seller to the buyer.

In order to use the social networking website 140, the parties to the transaction 142 create a personalized user account. The system administrator may require that the parties submit proof of any licenses required for that party's profession before activating the account. Potential buyers, or other members of the public, desiring to search for properties may also create a profile that will allow them to view the public section 150. The identification of such parties is documented by the system 10 but is preferably not revealed to others. Their identification, however, is preferably required to access a private section 148.

An exemplary implementation of the social networking website 140 for use in a real estate transaction will now be described in more detail. The parties to the transaction 142 initially query the profile administrator 144 to provide access to the private section 148. If the profile administrator 144 accepts, the parties are allowed to view and interact with the private section 148. The private section 148 serves as a central hub of communication for the parties. Each step of the transaction and negotiations may take place in the private section 148. The private section 148 may serve as a central hub of communication with the property owner outside of a transaction as well, such as, for the communication of legal notifications, delivery of documents and consolidation of house hold electronics communications.

A typical transaction proceeds as follows. Initially, a buyer becomes interested in a property that has a property profile 146. The buyer creates a profile and contacts the profile administrator 144 to provide access to the private section 148. If the buyer desires to make an offer, he or she will preferably first contact a lender and obtain a prequalification letter. The buyer may contact a lender with a profile on the social networking website 140 to accomplish this. The buyer or the buyer's agent then uploads the prequalification letter to the private section 148. Alternatively, the buyer may upload proof of the buyer's ability to purchase the property to the private section 148. The owner reviews this information and considers the buyer as a “qualified buyer” for the subject property. The buyer may make an offer by uploading a contract to the private section 148. Once the contract is uploaded, the status indicator indicates “contract pending” or the like. If a deposit is to be made, an escrow agent is chosen and is provided access to the private section 148 by the profile administrator 144. Once the deposit is made, the escrow agent confirms receipt in the private section 148. The contract terms are negotiated and revised and finally accepted by the buyer and seller. The executed contract is uploaded to the private section 148 and the status indicator is changed to “under contract” or the like.

Next, a property inspector is be selected and is provided access to the private section 148 by the profile administrator 144. Once the property inspection is complete, the inspector uploads the inspection report to the private section 148.

A mortgage provider may is selected and is provided access to the private section 148 by the profile administrator 144. The mortgage provider inspects the documents needed for underwriting through the buyer's profile and/or the private section 148. Examples of these documents include the inspection report, title insurance, and good faith estimate among others. When underwriting is complete, the mortgage provider indicates in the private section 148 that the loan has been cleared to close.

Once closing occurs, the executed documents are uploaded to the private section 148, their execution may be confirmed by a professional suited to confirm that ownership of the property and control of the property profile 146 has been transferred, or both. At that point the status indicator may change to indicate that the transaction is closed. Upon verification of the transaction's closure, the status indicator change to indicate that the property is not for sale or is owned by a new owner.

A system interface 152 on the social networking interface 140 is in data communication with the system 10 for allowing each party 142 to obtain a ROI value that is tailored to that party's input for the property. For example, if the party is a buyer, the computer system 12 displays the previously described data fields at the system interface 152. In another example, if the party is the seller, the computer system 12 displays data fields directed to the sales price defined in the contract or the listing price at the system interface 152. Additional data may be input via the system interface 152 by the other parties to the transaction 142, and taken from public and/or private industry records.

Because the property profile 146 is in data communication with the system 10, updates to the property profile 146 may be used to re-calculate the ROI value for the property. In the context of FIG. 7, the system 10 inputs these updates at block 136. Advantageously, by doing so, the system 10 is adapted to provide the mortgage agent 22 with more valuable information. For example, if a mortgagee 20 lists the mortgaged property as being for sale on the property profile 146, the system 10 communicates this fact to the mortgage agent 22. This is an additional forward-in-time-looking data point indicative that the mortgage is likely to be prepaid.

The social networking interface 140 provides additional benefits. For example, tax collection may be another parameter to complete in the real estate transaction. Also, since all of the parties are well-identified and all of the transaction documents are placed onto the private section 148, fraud is more easily identified and avoided.

The real estate data stored in the real estate database 32 can be used in many alternative ways. Some of the alternative uses for the data are now described. The database 32 may be used to create a national “heat map,” in which a color coded indicator associated with ROI values calculated by the system 10 is overlayed on a map. Other heat maps, such as a heat map based on forward looking sentiment input by the users 20-24, a heat map based on historical data, or a heat map based on current expectations (desired ROI value, desired sales price, etc) of the users 20-24. By using the ROI value and, optionally, standardized inputs for financing, expenses, and years owned it is possible to calculate ROI value for a nationwide property comparison. Other heat maps that may be generated using the data in the database include, but are not limited to, a heat map made using the information a potential buyer inputs into the system 10, such as a heat map of ROI values that are calculated according to the potential buyer's specified criteria; a heat map of all the internal rates of return for mortgages in the database 32; a heat map of the date of the origination terms & pay off date; a heat map of the timing of the payoff of a mortgage indicated either by the mortgagee or potential buyer who has provided an estimate of the amount of time it intends to own the property.

Using the database 32, the interface 140 also functions as a real estate listing service similar to or in cooperation with the Multiple Listing Service (MLS). Optionally, it may be linked with existing MLS originations, or licensed to a firm for use with its listings. In use, when a buyer goes to a real estate professional to buy a property, the real estate professional visits the website and input that buyers financing details, down payment, etc. After the buyer-specific inputs are entered, the expenses are standardized and a more buyer personalized search is performed to locate the property with the highest ROI value for the buyer. Both buyer and seller provide inputs for the calculation. A list of exemplary questions that are presented to the buyer are: how long will the buyer own the property; whether the buyer will use a real estate professional to sell; an estimated annual growth rate for calculating the buyer's future sales price; expense estimates to calculate carrying costs; the financing terms the buyer has pre-qualified for and plans to use in the purchase. The seller may provide: the current sales price; rental income information (amounts, vacancy); expense estimates to calculate operating expenses; and estimates of any significant upcoming maintenance such as a new roof or other major upgrades.

Using the database 32, the social networking interface 140 may also be used as a sales aid by real estate professionals and mortgage industry entities such as mortgage agents 22. Real estate professionals can use the website to help in the pricing of a house by answering the seller's question “What would my ROI score be if I sold the house for price X?” in a so-designated data field. Similarly the social networking interface 140 may be used by potential buyers to calculating the maximum amount the potential buyer should pay for the property taking into account the potential buyer's desired ROI value. The website may also be used to help buyers choose between properties by allowing them to compare potential ROI values on various properties. In this context, the real estate professional can provide its client with information needed to log in to the website. On the social networking interface 140, the real estate professional's client can look at ROI values that the real estate professional has calculated for the client and the client can search other public profiles by the client's desired ROI value. A print out of the results page that includes the real estate professional's contact info may also be generated.

Mortgage agents 22 can use the website 140 and database 32 to help their clients choose between loans by calculating the potential ROI values using different loans.

The social networking interface 140 and database 32 may also be used to aid in asset allocation decisions and retirement planning. Asset allocation is the most common conversation type that financial professionals have with clients. By including real estate in the conversation, the financial professional can also provide input on the liquidity risk to which real estate exposes the investor. This may reasonably lead the advisor to suggest higher cash levels and a different overall allocation mix for the investor. Here, the ROI values are preferably combined with existing asset allocation tools. This advantageously allows financial professionals to give clients advice inclusive of their real estate holdings. Such comprehensive advice is typically offered only to very wealthy investors, but not on a mass scale due to the time and expertise needed to analyze the real estate element.

Alternatively, the social networking interface 140 can engage the investor directly. The investor can create an account and enter their assets such as stocks, bonds, certificates of deposition (“CDs”), retirement accounts, cash, annuities, insurance, and real estate. Using this list, the investor's total net worth is calculated. Then, the percentage of net worth each asset class makes up is determined. Existing financial planning tools can assign a growth rate to each asset class (except real estate) and forecast the investor's probable future financial position. The ROI values can then be used to do the same for the real estate asset class.

The social networking interface 140 advantageously allows real estate financial analysis to be performed quickly and at low cost compared to conventional techniques. To generate an even more efficient analysis, the system 10 uses the real estate data for a piece of property that is provided by another source and imported it into the database 32. For example, it is possible to obtain an estimate of the property's current value using a pre-existing website that provides that information and, using the appraised value as a base number, the current equity can be calculated. Once the investor completes the rest of the questions on the website, the system preferably calculates two elements that integrate with current financial planning tools: (1) current equity, used to determine what percentage of an investor's net worth is in real estate and (2) the expected ROI score to be applied to the equity in real estate. Although some existing financial planning tools ask how much a home is worth and the mortgage balance, including mortgage pay down, to calculate equity, there is presently no source for a reasonably accurate ROI value to apply to the amount of equity. The system 10 is combinable with financial industry tools in deeper detail by categorizing the real estate element as well.

The computer system 12 is adaptable to query a pre-existing website that performs automated accounting services for its users to provide financial information about a particular borrower, receive financial information about the mortgagee, and store the mortgagee's financial information in the database 32. This information may be combined with data entered by the mortgagee 20 for calculating the mortgagee's ROI value. This creates an opportunity to let real estate professionals market real estate and mortgages to the users of the accounting services website, promoting personalized ROI.

The property profile 146 may be used to create a living chain of title. In this example, when a property is sold, the profile administrator 144 shifts from being under the seller's control to being under the buyer's control. The system 10 then prevents the seller from gaining access to the private section 146.

Real estate investors may use the social networking interface 140 to make bids on property that have a property profile 146. In this context, the system is adaptable to allow investors to input standing bids to buy a property if the property meets the investor's criteria. The investor's criteria may be a desired ROI value, price range, or a combination of desired ROI value and price range.

The computer system 12 may be further adapted to allow investors to purchase credits where each credit corresponds to a dollar amount. The investor may then use the credits to purchase property. For example, if the investor makes a standing bid for a property, the computer system 12 will automatically submit an offer for the property using the credits if the investor's bid criteria are met.

REO scenario-forward looking data used as pricing mechanism in event of foreclosure. Can reduce liquidity risk in real estate market.

In the specification set forth above there have been disclosed typical preferred embodiments of the invention, and although specific terms are employed, the terms are used in a descriptive sense only and not for purposes of limitation. The invention has been described in some detail, but it will be apparent that various modifications and changes can be made within the spirit and scope of the invention as described in the foregoing specification and as defined in the appended claims.

That which is claimed is:

1. A computer-based system for providing mortgage prepayment risk information, the system comprising:
tangible memory storing real estate data associated with an article of real property and mortgage data associated with a mortgage for the real property, the mortgage data comprising a first mortgagee defined time period for maintaining the mortgage;
a computer system having at least one processor operably coupled to the tangible memory, the computer system being configured to:
calculate a first return on investment value based on the mortgage data; and
provide a mortgage agent with the first mortgagee defined time period.

2. The system of claim 1, wherein the computer-based system is further configured to:
receive updated mortgage data subsequent to calculating the first return on investment value, the updated mortgage data including a second mortgagee defined time period for maintaining the mortgage;
calculate a second return on investment value based on the updated mortgagee data; and
provide the mortgage agent with the second mortgagee defined time period.

3. The system of claim 1, wherein the first mortgagee defined time period is a time period associated with an estimated amount of time the mortgagee expects to own the real property and is input by the mortgagee at a mortgagee interface executed by the computer system.

4. The computer-based system of claim 1, wherein the computer system is further configured to:
receive a request from the mortgage agent to obtain the mortgage data for an article of real property specified by the mortgage agent;
determine whether a pre-existing return on investment value for the specified article of real property is stored in the tangible memory;
transmit a communication to the mortgagee of the specified article of real property, the communication being a request to input the mortgage data;
receive the mortgage data associated with the mortgagee of the specified article of real property; and
wherein:
the first return on investment value is based on the received mortgage data; and
the first mortgagee defined time period is defined by the mortgagee of the specified article of real property.

5. The computer-based system of claim 4, wherein the computer system is further configured to:
receive updated mortgage data subsequent to calculating the first return on investment value, the updated mortgage data including a second mortgagee defined time period for maintaining the mortgage;
calculate a second return on investment value based on the updated mortgage data; and
provide the mortgage agent with the second mortgagee defined time period.

6. The computer-based system of claim 1, wherein the computer system is further configured to:
execute an interface for allowing a plurality of parties to a real estate transaction for the article of real property to communicate data associated with the real estate transaction to the memory;
display the communicated data associated with the real estate transaction on the interface;
receive updates related to the sales status of the article of real property; and
transmit the sales status to the mortgage agent.

7. The computer-based system of claim 6, wherein the computer system is further configured to:
receive a request from the mortgage agent to obtain the mortgage data for an article of real property specified by the mortgage agent;
determine whether a pre-existing return on investment value for the specified article of real property is stored in the tangible memory;
transmit a communication to the mortgagee of the specified article of real property, the communication being a request to input the mortgage data;
receive the mortgage data associated with the mortgagee of the specified article of real property, the mortgage data associated with the mortgagee of the specified article of real property being used to calculate the first return on investment value and provide the first mortgagee defined time period;
receive updated mortgage data subsequent to calculating the first return on investment value, the updated mortgage data including a second mortgagee defined time period for maintaining the mortgage;
calculate a second return on investment value based on the updated mortgage data; and
provide the mortgage agent with the second mortgagee defined time period.

8. A computer-based method for providing mortgage prepayment risk information, the method comprising:
receiving real estate data associated with an article of real property and mortgage data associated with a mortgage of the real property, the mortgage data comprising a first mortgagee defined time period for maintaining the mortgage;
storing the real estate data and mortgage data on tangible machine readable memory;
calculating a first return on investment value by applying a return on investment algorithm to the mortgage data using a computer processor in data communication with the tangible machine readable memory; and
providing a mortgage agent with the first mortgagee defined time period.

9. The computer-based method of claim 8, further comprising:
receiving updated mortgage data subsequent to calculating the first return on investment value, the updated mortgage data including a second mortgagee defined time period for maintaining the mortgage;
calculating a second return on investment value based on the updated mortgage data by applying the return on investment algorithm to the updated mortgage data; and
providing the mortgage agent with the second mortgagee defined time period.

10. The computer-based method of claim 8, wherein the first mortgagee defined time period is a time period associated with an estimated amount of time the mortgagee expects to own the real property and is input by the mortgagee at a mortgagee interface executed by the computer system.

11. The computer-based method of claim 8, further comprising:
receiving a request from the mortgage agent to obtain the mortgage data for an article of real property specified by the mortgage agent;
determining whether a pre-existing return on investment value for the specified article of real property is stored in the memory;
transmitting a communication to the mortgagee of the specified article of real property, the communication being a request to input the mortgage data; and
receiving the mortgage data associated with the mortgagee of the specified article of real property;
wherein:
the first return on investment value is based on the received mortgage data; and
the first mortgagee defined time period is defined by the mortgagee of the specified article of real property.

12. The computer-based method of claim 11, further comprising:
receiving updated mortgage data subsequent to calculating the first return on investment value, the updated mortgage data including a second mortgagee defined time period for maintaining the mortgage;
calculating a second return on investment value based on the updated mortgage data by applying the return on investment algorithm to the updated mortgage data; and
providing the mortgage agent with the second mortgagee defined time period.

13. The computer-based method of claim 8, further comprising:
executing an interface for allowing a plurality of parties to a real estate transaction for the article of real property to communicate data associated with the real estate transaction to the memory;
displaying communicated data associated with the real estate transaction on the interface;
receiving an update related to the sales status of the article of real property; and
transmitting the sales status to the mortgage agent.

14. The computer-based method of claim 13, further comprising:
receiving a request from the mortgage agent to obtain the mortgage data for an article of real property specified by the mortgage agent;
determining whether a pre-existing return on investment value for the specified article of real property is stored in the tangible memory;
transmitting a communication to the mortgagee of the specified article of real property, the communication being a request to input the mortgage data;
receiving the mortgage data associated with the mortgagee of the specified article of real property, the mortgage data associated with the mortgagee of the specified article of real property being used to calculate the first return on investment value and provide the first mortgagee defined time period;
receiving updated mortgage data subsequent to calculating the first return on investment quantity, the updated mortgage data including a second mortgagee defined time period for maintaining the mortgage;
calculating a second return on investment value based on the updated mortgage data by applying the return on investment algorithm to the updated mortgage data; and
providing the mortgage agent with the second mortgagee defined time period.

15. A computer-based method for evaluating mortgage prepayment risk, the method comprising:
receiving, at a first computer interface, a first mortgagee defined time period for maintaining a mortgage, the first mortgagee defined time period being obtained from a computer system configured to:
store real estate data associated with an article of real property and mortgage data associated with a mortgage for the real property on machine readable memory, the mortgage data comprising the first mortgagee defined time period; and
calculate a first return on investment value by applying a return on investment algorithm to the mortgage data using a computer processor in data communication with the memory.

16. The computer-based method of claim 15, further comprising:
receiving, at a second computer interface, a second mortgagee defined time period for maintaining the mortgage;
wherein the computer system is further configured to:
receive updated mortgage data subsequent to calculating the first return on investment value, the updated mortgage data including the second mortgagee defined time period for maintaining the mortgage; and
calculate a second return on investment value by applying the return on investment algorithm to the updated mortgage data using the computer processor.

17. The computer-based method of claim 15, wherein the first mortgagee defined time period is a time period associated with an estimated amount of time the mortgagee expects to own the real property and is input by the mortgagee at a mortgagee interface executed by the computer system.

18. The computer-based method of claim 15, wherein the computer system is further configured to:
receive a request to obtain the mortgage data for a specified article of real property;
determine whether a pre-existing return on investment value for the specified article of real property is stored in the machine readable memory;
transmit a communication to the mortgagee of the specified article of real property, the communication being a request to input the mortgage data; and
receive the mortgage data associated with the mortgagee of the specified article of real property.

19. The computer-based method of claim 18, further comprising:
receiving, at a second computer interface, a second mortgagee defined time period for maintaining the mortgage;
wherein the computer system is further configured to:
receive updated mortgage data subsequent to calculating the first return on investment value, the updated mortgage data including the second mortgagee defined time period for maintaining the mortgage; and
calculate a second return on investment value by applying the return on investment algorithm to the updated mortgage data using the computer processor.

20. The computer-based method of claim 15, further comprising:
receiving an update to the sales status of the article of real property;
wherein the computer system is further configured to:
execute a second computer interface for allowing a plurality of parties to a real estate transaction for the article of real property to communicate data associated with the real estate transaction to the memory;
display the communicated data associated with the real estate transaction on the second computer interface; and
receive updates related to a sales status of the article of real property.

21. The computer-based method of claim 20, further comprising:
receiving, at a second computer interface, a second mortgagee defined time period for maintaining the mortgage;
wherein the computer system is further configured to:
receive updated mortgage data subsequent to calculating the first return on investment value, the updated mortgage data including the second mortgagee defined time period for maintaining the mortgage;
calculate a second return on investment value by applying the return on investment algorithm to the updated mortgage data using the computer processor;
receive a request to obtain the mortgage data for an article of real property specified by the mortgage agent;
determine whether a pre-existing return on investment value for the specified article of real property is stored in the tangible memory;
transmit a communication to the mortgagee of the specified article of real property, the communication being a request to input the mortgage data; and
receive the mortgage data associated with the mortgagee of the specified article of real property, the mortgage data associated with the mortgagee of the specified article of real property being used to calculate the first return on investment value and provide the first mortgagee defined time period.
